(19) United States
(12) Patent Application Publication
(10) Pub. No.: US 2009/0056198 A1
(43) Pub. Date: Mar. 5, 2009

(54) Bristle stone aquarium worm trap

(76) Inventor: Loren Fanony, Puyallup, WA (US)

Correspondence Address: Donald W. Meeker, 924 East Ocean Front #E, Newport Beach, CA, 92661, US

(21) Appl. No.: 11/897,490

(22) Filed: Aug. 30, 2007

(51) Int. Cl. A01M 23/02

(52) U.S. Cl. 43/58

(57) ABSTRACT

A bristle stone worm trapping device is made from or concealed within a rock, which may be a live rock. The trapping device may be made by cutting a rock in two, drilling a bait holding cavity within the rock, and drilling bait access tunnel holes in the rock. Alternately the trapping device may be made by simply drilling a cylindrical opening in the rock forming an inner bait holding cavity and means for accessing the bait holding cavity. Bait is placed within the cavity or cylindrical opening. Alternately a plastic or PVC bait holding tube or pipe having end caps and sidewalls with bait access holes therein may be placed inside the cavity or cylindrical opening drilled in the rock.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to traps and to saltwater aquariums and the maintenance thereof and particularly to a bristle stone worm trap device which is made from or concealed within a stone or rock, which may be a live rock, thereby providing a more attractive trap which simulates the bristle worm's normal home; the trap device is made by either cutting a rock in two, drilling a bait-holding cavity within the rock, and drilling bait access holes in the rock, or by simply drilling a cylindrical opening in the rock, the bait is then placed within the cavity or cylindrical opening; alternately a plastic or PVC bait-holding pipe having end caps and sidewalls with bait access holes therein may be placed inside the cavity or cylindrical opening drilled in the rock.

2. Description of Related Art Including Information Disclosed Under 37 CFR 1.97 and 1.98

A salt water aquarium tank typically includes coral and live rocks which form a simulated reef. Live rocks include living organisms. A live rock sustains a variety of living organisms such as crustaceans, worms, clams, algae, sponges, and bacteria. At times, destructive bristle worms are inadvertently introduced into the aquarium. The bristle worms are highly prolific and can kill corals and eat clams, fish and other reef inhabitants. They need to be removed from the tank in order to preserve the condition of the simulated reef.

Prior art devices trap worms however; they are not concealed in a live rock and can detract from the appearance of the salt water aquarium.

Two U.S. Pat. No. 5,568,790 issued Oct. 29, 1996 and U.S. Pat. No. 5,297,513 issued Mar. 29, 1994 to Musgrave, show a worm trap for use in an aquarium for trapping worms. The worm trap includes a tube assembly having a pair of openings at the ends of the assembly. A chamber is located within the assembly and is adapted to contain a food morsel. At least one end wall of the chamber communicates with the interior of the tube assembly to allow the aroma of the food morsel to enter the tube assembly so that a worm will be attracted to the aroma and be trapped in the tube assembly. The opening in the chamber is sufficiently small to prevent the food morsel from being carried out of the tube assembly by the worm.

U.S. Pat. No. 6,874,274 issued Apr. 5, 2005 to Townsend, provides a tamper-resistant pest trap that has an outer housing that simulates a rock typically found in a garden or landscape area around a residence or building. The outer housing includes a substantially flat bottom member and a pivotally attached upper dome-shaped lid member. When the lid member is closed over the bottom member, a large cavity is formed inside the trap. Formed on the bottom member are two, inward extending tunnel cavities that form two partially concealed tunnels that extend under the trap when the trap is placed on the ground. Formed on the perimeter edge of the outer housing is an outer pest opening. From on the bottom member directly over the tunnel cavity is an inner pest opening that allows a rodent to enter the large cavity after traveling through the tunnel. Formed inside the outer housing is a holding tray designed to hold a rodentocide or a mechanical trap capable of killing the rodent. An optional bait paper tray is also formed in the bottom member to hold bait paper. An optional lock is provided to prevent tampering and stake and hold-down chain are provided to attach the trays to the ground.

What is needed is a bristle worm trap which is made from or concealed within a rock with an interior bait holding cavity holding bristle worm bait with bait access tunnels leading to the interior bait holding cavity for trapping bristle worms in a salt water aquarium, thereby providing a more attractive trap which simulates the bristle worm's normal home.

### BRIEF SUMMARY OF THE INVENTION

An object of the present invention is to provide a bristle worm trap which is made from or concealed within a rock, which may be a live rock, with an interior bait holding cavity holding bristle worm bait with bait access tunnels leading to the interior bait holding cavity for trapping bristle worms in a salt water aquarium, thereby providing a more attractive trap which simulates the bristle worm's natural home.

Another object of the present invention is to prevent the bristle worms' consumption of fish food or other inhabitants in the aquarium by providing bait for the worms to eat and removing the bristle worms from the aquarium.

One more object of the present invention is to prevent the bristle worms' destruction of coral in the aquarium by removing the bristle worms from the aquarium.

In brief, a bristle stone worm trapping device which is made from or concealed within a rock, thereby providing a more attractive trap which simulates the bristle worn's natural home. The trapping device is made by either cutting a rock in two, drilling a bait holding cavity within the rock, and drilling bait access tunnel holes in the rock, or by simply drilling a cylindrical opening in the rock forming an inner bait holding cavity and means for accessing the bait holding cavity, the bait is then placed within the cavity or cylindrical opening; alternately a plastic or PVC bait holding tube or pipe having end caps and sidewalls with bait access holes therein may be placed inside the cavity or cylindrical opening drilled in the rock.

The purpose of the device is to remove bristle worms from a salt water aquarium to prevent the bristle worms from damaging coral in the salt water aquarium and from eating other inhabitants in the aquarium.

An advantage of the present invention is that it prevents the damage or destruction of coral in the aquarium.

One more advantage of the present invention is that it is an attractive, natural addition to the aquarium.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a perspective view of the split bristle stone worm trapping device of the present invention;

FIG. 2 is a perspective view of the split bristle stone worm trapping device of FIG. 1 showing the device split in half for access to the bait holding tube in the inner bait holding cavity;

FIG. 3 is a perspective view of an alternate embodiment of the bristle stone worm trapping device having a large diameter hole drilled into the stone to create the inner bait holding cavity showing the bait holding tube in the inner bait holding cavity (dashed lines);

FIG. 4 is a perspective view of the split bristle stone worm trapping device of FIG. 1 showing one the devices at the bottom of the salt water aquarium and another of the devices being held by a mesh scoop for either installing the device in the salt water aquarium to attract bristle worms or removing the device from the salt water aquarium to remove the bristle worms in the device.

### DETAILED DESCRIPTION OF THE INVENTION

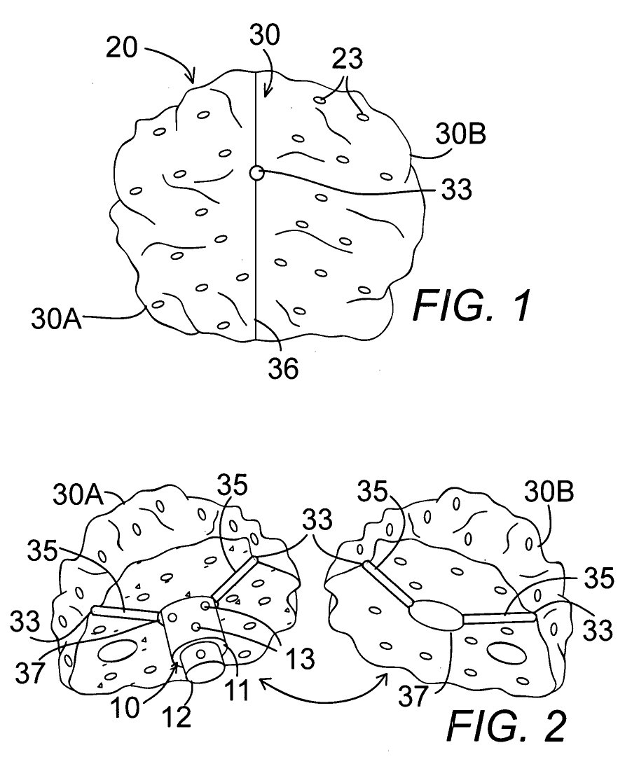

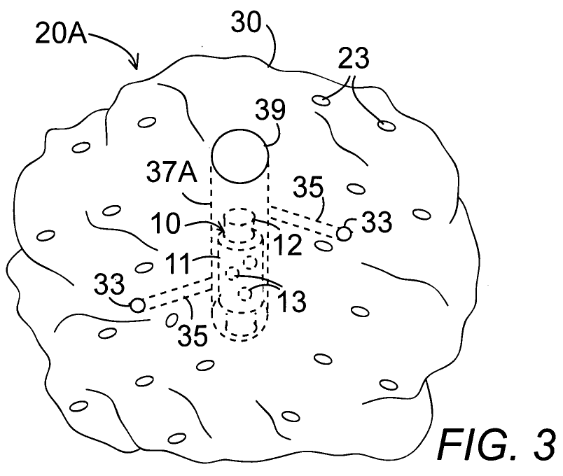

In FIGS. 1-4, a bristle worm trapping device 20 and 20A for salt water aquariums 40 comprises either a split stone embodiment of the bristle worm trapping device 20 of FIGS. 1, 2, and 4 or an alternate embodiment with a drilled interior bait holding cavity in the bristle worm trapping device 20A of FIG. 3.

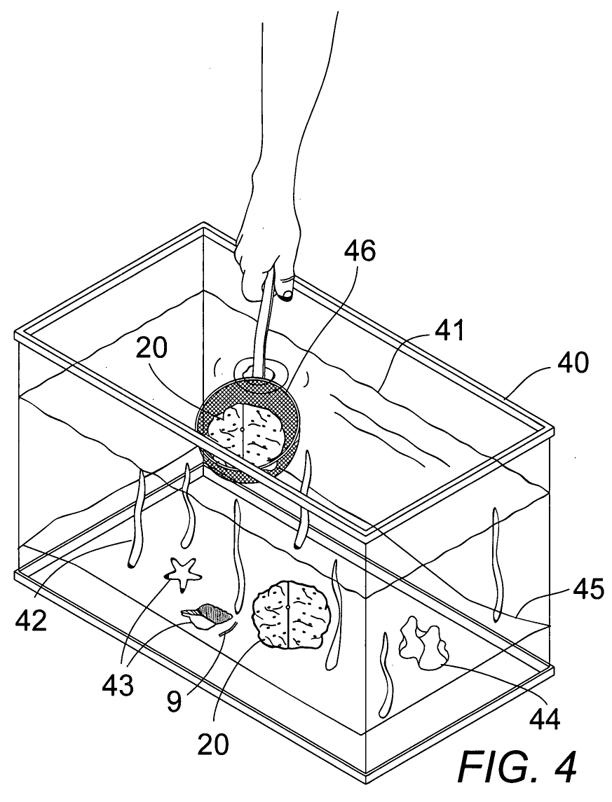

The bristle worm trapping device in the form of a stone or rock 20 and 20A, which may be a live rock, simulates a bristle worm's natural home to attract bristle worms 9, as shown in FIG. 4. The bristle stone trap 20 and 20A comprises a rock 30, which may be a live rock. The bristle stone 30 comprises at least one interior bait holding cavity 37 and 37A formed therein to contain bristle worm bait to attract the bristle worms to enter the bristle stone trap. At least one bait access tunnel 35 is formed in the bristle stone 30, extending between the interior bait holding cavity 37 and 37A and at least one exterior opening 33 to admit bristle worms to pass through the exterior opening and the bait access tunnel 35 into the interior bait holding cavity 37 and 37A to eat the bristle worm bait placed in the interior bait holding cavity. A means for accessing the interior bait holding cavity, either by an opening 39 to the bait holding cavity, shown in FIG. 3, or by a split 36 in the bristle stone, shown in FIGS. 1 and 2, allows the loading of the bristle worm bait prior to placement of the bristle stone trap 20 and 20A in a salt water aquarium 40 to trap the bristle worms 9 and to remove trapped bristle worms from the interior bait holding cavity 37 and 37A after removing the bristle stone trap from the salt water aquarium, as shown in FIG. 4.

In FIGS. 2 and 3, the bristle stone worm trapping device 20 and 20A further comprises a bait holding tube 10 removably inserted in the interior bait holding cavity 37 and 37A. The bait holding tube comprises a hollow cylinder 11 for holding the bristle worm bait, an end cap 12 at each end of the hollow cylinder for retaining the bristle worm bait therein, and a plurality of holes 13 in the hollow cylinder and the end caps for admitting the bristle worms therethrough to access the bristle worm bait.

The bait holding tube hollow cylinder 11 may be fabricated from a section of plastic pipe, or a section of polyvinyl chloride pipe.

In FIGS. 1 and 2, in one embodiment, the device 20 comprises a split 36 in the bristle stone 30 formed by cutting the live rock into at least two bristle stone pieces 30A and 30B so that the pieces are separable to openly access the interior bait holding cavity 37 for loading of the bristle worm bait into the interior bait holding cavity 37 and removing trapped bristle worms from the interior bait holding cavity, as shown in FIG. 2. In this embodiment, the interior bait holding cavity 37 comprises a mating cylindrical opening drilled into each of two mating pieces of the bristle stone. The two mating cylindrical openings mate together to form the bait holding cavity 37 when the bristle worm bait is placed in the two mating cylindrical openings and the two mating pieces of the bristle stone are joined together in the shape of the original live rock 30 to form the bristle stone trap 20.

In FIG. 3, in another embodiment, the interior bait holding cavity 37A comprises a cylindrical opening 39 drilled from the exterior cavity opening 39 of the rock 30 to the interior of the bristle stone. The cylindrical opening 37A is sufficiently large to allow the loading of the bait holding tube 10 in the bristle stone 30, and the removal of the bait holding tube 10 to remove the trapped bristle worms from the bristle stone.

In FIGS. 1, 2, and 3, the bait access tunnels 35 comprise a plurality of openings 33 drilled into the rock 30 between the interior bait holding cavity 37 and 37A and the exterior tunnel opening 33 of the rock, thereby creating a plurality of bait access tunnels 35.

In FIG. 4, a mesh scoop 46 installs the device 20 in the sand 45 in the salt water aquarium 40 among the sea plants 42, coral 44 and other sea creatures 43 to attract bristle worms 9. The mesh scoop 46 also removes the device from the salt water 41 in the aquarium 40 to remove the bristle worms 9 in the device 20.

In use, a bristle worm trapping method for salt water aquariums comprises a first step of cutting a rock, which may be a live rock, into at least two mating pieces 30A and 30B (as shown in FIG. 2) assembled together to form a bristle stone trap 20 to simulate a bristle worm's natural home to attract bristle worms.

A second step comprises drilling a mating cylindrical opening into each of two mating pieces of the bristle stone, allowing the two mating cylindrical openings to mate together to form at least one interior bait holding cavity 37 when the at least two pieces of live rock are joined together to contain bristle worm bait in the interior bait holding cavity to attract the bristle worms to enter the bristle stone trap.

A third step comprises drilling at least one bait access tunnel 35 in the rock extending between the at least one interior bait holding cavity 37 and at least one exterior opening 33 to admit bristle worms to pass through the at least one exterior opening and the at least one bait access tunnel 35 into the at least one interior bait holding cavity 37 formed therein to eat the bristle worm bait placed in the at least one interior cavity. Alternately, the third step comprises drilling a plurality of bait access tunnels into the rock between the interior bait holding cavity and the exterior of the rock.

A fourth step comprises loading in the bristle worm bait into the interior bait holding cavity with the at least two pieces 30A and 30B of bristle stone 30 separated and joining the at least two mating pieces of the bristle stone together in the shape of the original live rock to form the bristle stone trap 20.

A fifth step comprises placing the bristle stone trap in a salt water aquarium 40 to trap the bristle worms 9, as shown in FIG. 4.

A sixth step comprises removing the bristle stone trap from the salt water aquarium and separating the at least two pieces of bristle stone 30A and 30B to remove the trapped bristle worms from the at least one interior bait holding cavity 37.

The method may further comprise the step of placing a removable end cap 12 on each end of a hollow cylindrical tube 11 for holding the bristle worm bait and drilling a plurality of holes 13 in the hollow cylindrical tube and end caps to admit the bristle worms there through to access the bristle worm bait, thereby forming a bait holding tube 10 and inserting a removable bait holding tube in the interior bait holding cavity 37 with the at least two pieces of live rock 30A and 30B separated for accessing the interior bait holding cavity.

An alternate bristle worm trapping method for salt water aquariums comprises a first step of drilling at least one cylindrical opening 39 from the exterior of a rock 30 to the interior of the bristle stone. The cylindrical opening 39 is sufficiently large so that it comprises in combination an interior bait holding cavity 37A and a means for accessing the interior bait holding cavity to contain bristle worm bait therein to form a bristle stone trap to simulate a bristle worm's natural home to attract bristle worms.

A second step comprises drilling at least one bait access tunnel 35 in the rock 30 extending between the at least one interior bait holding cavity 37A and at least one exterior opening 33 to admit bristle worms to pass through the at least one exterior opening 33 and the at least one bait access tunnel 35 into the at least one interior bait holding cavity 37A formed therein to eat the bristle worm bait placed in the at least one interior cavity. The second step preferably comprises drilling a plurality of bait access tunnels 35 into the live rock between the interior bait holding cavity and the exterior of the rock.

A third step comprises loading the bristle worm bait into the interior bait holding cavity 37A.

A fourth step comprises placing the bristle stone trap in a salt water aquarium 40 to trap the bristle worms 9, as shown in FIG. 4.

A fifth step comprises removing the bristle stop trap 20A from the salt water aquarium and removing the trapped bristle worms from the at least one interior bait holding cavity 37A.

This method may further comprise a step of placing a removable end cap 12 on each end of a hollow cylindrical tube 11 for holding the bristle worm bait and drilling a plurality of holes 13 in the hollow cylindrical tube and end caps to admit the bristle worms therethrough to access the bristle worm bait thereby forming a bait holding tube 10 and inserting a removable bait holding tube in the interior bait holding cavity 37A.

It is understood that the preceding description is given merely by way of illustration and not in limitation of the invention and that various modifications may be made thereto without departing from the spirit of the invention as claimed.

What is claimed is:

1. A bristle worm trapping device for salt water aquariums, the device comprising:
a bristle stone trap to simulate a bristle worm's natural home to attract bristle worms, the bristle stone trap comprising a rock, the bristle stone comprising at least one interior bait holding cavity formed therein to contain bristle worm bait to attract the bristle worms to enter the bristle stone trap, at least one bait access tunnel formed therein extending between the at least one interior bait holding cavity and at least one exterior opening to admit bristle worms to pass through the at least one exterior opening and the at least one bait access tunnel into the at least one interior bait holding cavity formed therein to eat the bristle worm bait placed in the at least one interior cavity, and a means for accessing the at least one interior bait holding cavity to load in the bristle worm bait prior to placement of the bristle stone trap in a salt water aquarium to trap the bristle worms and to remove trapped bristle worms from the at least one interior bait holding cavity after removing the bristle stone trap from the salt water aquarium.

2. The device of claim 1 further comprising a removable bait holding tube inserted in the interior bait holding cavity, the bait holding tube comprising a hollow cylinder for holding the bristle worm bait, an end cap at each end of the hollow cylinder for retaining the bristle worm bait therein, and a plurality of holes in the hollow cylinder and the end caps for admitting the bristle worms therethrough to access the bristle worm bait.

3. The device of claim 2 wherein the bait holding tube hollow cylinder comprises a section of plastic pipe.

4. The device of claim 2 wherein the bait holding tube hollow cylinder comprises a section of polyvinyl chloride pipe.

5. The device of claim 1 wherein the means for accessing the at least one interior bait holding cavity to load the bristle worm bait into the at least one interior bait holding cavity and to remove trapped bristle worms from the at least one interior bait holding cavity comprises a split formed in the bristle stone cutting the rock into at least two pieces so that the at least two pieces are separable to openly access the at least one interior bait holding cavity.

6. The device of claim 5 wherein the at least one interior bait holding cavity comprises a mating cylindrical opening drilled into each of two mating pieces of the bristle stone, the two mating cylindrical openings mating together to form the at least one interior bait holding cavity when the bristle worm bait is placed in the two mating cylindrical openings and the two mating pieces of the bristle stone are joined together in the shape of an original live rock to form the bristle stone trap.

7. The device of claim 6 further comprising a removable bait holding tube inserted in the interior bait holding cavity, the bait holding tube comprising a hollow cylinder for holding the bristle worm bait, an end cap at each end of the hollow cylinder for retaining the bristle worm bait therein, and a plurality of holes in the hollow cylinder and the end caps for admitting the bristle worms therethrough to access the bristle worm bait.

8. The device of claim 7 wherein the bait holding tube hollow cylinder comprises a section of plastic pipe.

9. The device of claim 7 wherein the bait holding tube hollow cylinder comprises a section of polyvinyl chloride pipe.

10. The device of claim 1 wherein the interior bait holding cavity comprises a cylindrical opening drilled from the exterior of the bristle stone to the interior of the bristle stone, the cylindrical opening sufficiently large so that it comprises in combination the interior bait holding cavity and the means for accessing the at least one interior bait holding cavity.

11. The device of claim 10 further comprising a bait holding tube removably inserted in the interior bait holding cavity, the bait holding tube comprising a hollow cylinder for holding the bristle worm bait, an end cap at each end of the hollow cylinder for retaining the bristle worm bait therein, and a plurality of holes in the hollow cylinder and the end caps for admitting the bristle worms therethrough to access the bristle worm bait.

12. The device of claim 11 wherein the bait holding tube hollow cylinder comprises a section of plastic pipe.

13. The device of claim 11 wherein the bait holding tube hollow cylinder comprises a section of polyvinyl chloride pipe.

14. The device of claim 1 wherein the at least one bait access tunnel comprises a plurality of bait access tunnels drilled into the bristle stone between the interior bait holding cavity and the exterior of the bristle stone.

15. A bristle worm trapping method for salt water aquariums, the method comprising:
a first step of cutting a rock into at least two mating pieces assembled together to form a bristle stone trap to simulate a bristle worm's natural home to attract bristle worms;
a second step of drilling a mating cylindrical opening drilled into each of two mating pieces of the bristle stone, the two mating cylindrical openings mating together to form at least one interior bait holding cavity when the at least two pieces of bristle stone are joined together to contain bristle worm bait in the interior bait holding cavity to attract the bristle worms to enter the bristle stone trap;
a third step of drilling at least one bait access tunnel in the bristle stone extending between the at least one interior bait holding cavity and at least one exterior opening to admit bristle worms to pass through the at least one exterior opening and the at least one bait access tunnel into the at least one interior bait holding cavity formed therein to eat the bristle worm bait placed in the at least one interior cavity;
a fourth step of loading in the bristle worm bait into the interior bait holding cavity with the at least two pieces of bristle stone separated and joining the at least two mating pieces of the bristle stone together in the shape of an original live rock to form the bristle stone trap;
a fifth step of placing the bristle stone trap in a salt water aquarium to trap the bristle worms; and
a sixth step of removing the bristle stone trap from the salt water aquarium and separating the at least two pieces of bristle stone to remove the trapped bristle worms from the at least one interior bait holding cavity.

16. The method of claim 15 further comprising the step of removably placing an end cap on each end of a hollow cylindrical tube for holding the bristle worm bait and drilling a plurality of holes in the hollow cylindrical tube and end caps to admit the bristle worms therethrough to access the bristle worm bait thereby forming a bait holding tube and removably inserting the bait holding tube in the interior bait holding cavity with the at least two pieces of bristle stone separated for accessing the interior bait holding cavity.

17. The device of claim 15 wherein the third step comprises drilling a plurality of bait access tunnels into the bristle stone between the interior bait holding cavity and the exterior of the bristle stone.

18. A bristle worm trapping method for salt water aquariums, the method comprising:
a first step of drilling at least one cylindrical opening from the exterior of a bristle stone to the interior of the bristle stone, the at least one cylindrical opening sufficiently large so that it comprises in combination an interior bait holding cavity and a means for accessing the interior bait holding cavity to contain bristle work bait therein to form a bristle stone trap to simulate a bristle worm's natural home to attract bristle worms;
a second step of drilling at least one bait access tunnel in the bristle stone extending between the at least one interior bait holding cavity and at least one exterior opening to admit bristle worms to pass through the at least one exterior opening and the at least one bait access tunnel into the at least one interior bait holding cavity formed therein to eat the bristle worm bait placed in the at least one interior cavity;
a third step of loading in the bristle worm bait into the interior bait holding cavity;
a fourth step of placing the bristle stone trap in a salt water aquarium to trap the bristle worms; and
a fifth step of removing the bristle stop trap from the salt water aquarium and removing the trapped bristle worms from the at least one interior bait holding cavity.

19. The method of claim 18 further comprising the step of removably placing an end cap on each end of a hollow cylindrical tube for holding the bristle worm bait and drilling a plurality of holes in the hollow cylindrical tube and end caps to admit the bristle worms therethrough to access the bristle worm bait thereby forming a bait holding tube and removably inserting the bait holding tube in the interior bait holding cavity.

20. The device of claim 18 wherein the second step comprises drilling a plurality of bait access tunnels into the bristle stone between the interior bait holding cavity and the exterior of the bristle stone.
